(19) United States
(12) Patent Application Publication
(10) Pub. No.: US 2023/0208894 A1
(43) Pub. Date: Jun. 29, 2023

(54) INTEGRATING A VIDEO FEED WITH SHARED DOCUMENTS DURING A CONFERENCE CALL DISCUSSION

(71) Applicant: Google LLC, Mountain View, CA (US)

(72) Inventors: Shuhei Iitsuka, Tokyo (JP); Matthew Martin Clack, Tokyo (JP); Allison Anderson McKee, San Diego, CA (US)

(21) Appl. No.: 17/563,612

(22) Filed: Dec. 28, 2021

(51) Int. Cl. H04L 65/401; H04L 65/403; H04N 7/15; H04L 12/18

(52) U.S. Cl. CPC H04L 65/4015; H04L 65/403; H04N 7/152; H04L 12/1831

(57) ABSTRACT

A graphical user interface (GUI) that enables presentation of electronic documents is provided to participants of a conference call. A document is identified for presentation to the participants. A first portion of the document includes a first video feed integration object and a second portion of the document includes a second video feed integration object. The first object indicates a first region of the first portion to include a first video feed associated with a first client device of a first participant. The second object indicates a second region of the second portion to include a second video feed associated with a second client device of a second participant. The first portion and/or the second portion of the document are provided via the GUI. The first video feed is to be included in the first region indicated by the first object. The second video feed is to be included in the second region indicated by the second object.

### TECHNICAL FIELD

Aspects and implementations of the present disclosure relate to integrating a video feed with a shared document during a conference call discussion.

### BACKGROUND

Video or audio-based conference call discussions can take place between multiple participants via a conference platform. A conference platform includes tools that allow multiple client devices to be connected over a network and share each other's audio data (e.g., voice of a user recorded via a microphone of a client device) and/or video data (e.g., a video captured by a camera of a client device, or video captured from a screen image of the client device) for efficient communication. A conference platform can also include tools to allow a participant of a conference call to share a document displayed via a graphical user interface (GUI) on a client device associated with the participant with other participants of the conference call.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for integrating a video feed with a shared document during a conference call discussion. In an implementation, a graphical user interface (GUI) that enables presentation of electronic documents is provided to participants of a video conference call. An electronic document is identified for presentation to the participants of the video conference call. A first portion of the electronic document includes a first video feed integration object and a second portion of the electronic document includes a second video feed integration object. The first video feed integration object indicates, for the first portion of the electronic document, a first region to include a first video feed associated with a first client device of a first participant of the video conference call. The second video feed integration object indicates, for the second portion of the electronic document, a second region to include a second video feed associated with a second client device of a second participant of the video conference call. At least one of the first portion or the second portion of the electronic document is provided for presentation to one or more of the participants of the video conference call via the GUI. The first video feed is to be included in the first region indicated by the first video feed integration object. The second video feed is to be included in the second region indicated by the second video feed integration object.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example conference platform and an example video feed integration engine, in accordance with implementations of the present disclosure.

FIGS. 3A-3C illustrate an example of designating one or more regions of an electronic document to include video feed of conference call participants during presentation of the electronic document, in accordance with implementations of the present disclosure.

FIGS. 4A-4C illustrate an example of integrating video feed of conference call participants with a shared electronic document during a conference call discussion, in accordance with implementations of the present disclosure.

FIG. 5 illustrates another example of designating one or more regions of an electronic document to include video feed of conference call participants during presentation of the electronic document, in accordance with implementations of the present disclosure.

FIGS. 6A-6B illustrate another example of integrating video feed of conference call participants with a shared electronic document during a conference call discussion, in accordance with implementations of the present disclosure.

FIGS. 7A-7B illustrate yet another example of designating one or more regions of an electronic document to include video feed of conference call participants during presentation of the electronic document, in accordance with implementations of the present disclosure.

FIG. 8 illustrates an example of a file generated for an electronic document, in accordance with implementations of the present disclosure.

FIG. 9 depicts a flow diagram of an example method for integrating a video feed with a shared document during a conference call discussion, in accordance with implementations of the present disclosure.

FIG. 10 is a block diagram illustrating an exemplary computer system, in accordance with implementations of the present disclosure.

### DETAILED DESCRIPTION

Aspects of the present disclosure relate to integrating a video feed with a shared document during a conference call discussion. A conference platform can enable video or audio-based conference call discussions between multiple participants via respective client devices that are connected over a network and share each other's audio data (e.g., voice of a user recorded via a microphone of a client device) and/or video data (e.g., a video captured by a camera of a client device) during a conference call. In some instances, a conference platform can enable a significant number of client devices (e.g., up to one hundred or more client devices) to be connected via the conference call.

It can be overwhelming for a participant of a live conference call (e.g., a video conference call) to engage other participants of the conference call using a shared document (e.g., a slide presentation document, a word processing document, a webpage document, etc.). For example, a presenter of a conference call can prepare a document including content that the presenter plans to discuss during the conference call. Existing conference platforms enable the presenter to share the document displayed via a GUI of a client device associated with the presenter with the other participants of the call via a conference platform GUI on respective client devices while the presenter discusses content included in the shared document. However, such conference platforms do not effectively display the content of the shared document while simultaneously displaying an image depicting the presenter via the conference platform GUI on the client devices associated with the other participants. For example, some existing conference platforms may not provide the image depicting the conference call presenter with the document shared via the conference platform GUI, which prevents the presenter from effectively engaging with the participants via a video feature of the conference platform. As a result, the attention of the conference call participants is not captured for long (or at all) and the presentation of the shared document during the conference call can come across as being impersonal or mechanical. Other existing conference platforms may display the content of the shared document via a first portion of the conference platform GUI and an image depicting the presenter via a second portion of the conference platform GUI. However, given that the image of the presenter is displayed in a separate portion of the conference platform GUI than the content of the shared document, participants may not be able to simultaneously focus on or concurrently observe the visual cues or gestures provided by the presenter while consuming the content provided by the shared document.

In some instances, multiple presenters can be associated with a document that is shared with participants of the conference call via the conference platform GUI. For example, two or more presenters can be associated with a shared document, where a first presenter is to discuss content included in a first portion of the shared document (e.g., a first slide of a slide presentation document, etc.), a second presenter is to discuss content included in a second portion of the shared document (e.g., a second slide of the slide presentation document, etc.), and so forth. Conventional systems do not enable presenters of a shared document to seamlessly transition a discussion between multiple different presenters. For example, when an electronic document is shared via a conventional conference platform, the electronic document can be presented via a first portion of the conference platform GUI and a video feed associated with one or more participants of the conference call (e.g., including the presenters) can be presented via a second portion of the conference call. The size of the first portion of the conference platform GUI can be significantly larger than the size of video feeds presented via the second portion of the conference platform GUI (e.g., and the size of the video feeds can be significantly small). Given that the size of the video feeds presented via the second portion of the conference platform GUI is small, a participant of the conference call discussion may not easily identify the video feed of a presenter of the shared document. The participant may also not easily detect when the presentation or discussion relating to the shared document transitions from a first presenter to a second presenter. For these additional reasons, conventional conference platforms do not enable conference call presenters to effectively engage with participants of the conference call discussion and do not enable the clear and effective transition between presenters.

Aspects of the present disclosure address the above and other deficiencies by providing techniques for integrating a video feed associated with one or more conference call presenters with a document shared via a conference platform GUI on client devices associated with participants of the conference call. A conference platform can provide a GUI that enables presentation of electronic documents to participants of a video conference call. A client device associated with a presenter of a conference call can transmit a request to the conference platform to initiate a document sharing operation to share an electronic document (e.g., a slide presentation document, etc.) displayed via a GUI for the client device with participants of the conference call via GUIs on client devices associated with participants of the conference call. A first portion of the electronic document (e.g., a first slide, a first portion of a first slide, etc.) can include a first video feed integration object. The first video feed integration object can indicate a first region of the first portion of an electronic document that is to include a video feed generated by a first client device of a first participant of the conference call (e.g., the presenter or another participant of the conference call). In some embodiments, a second portion of the electronic document (e.g., a second slide, a second portion of a second slide, etc.) can include a second video feed integration object. The second video feed integration object can indicate a second region of the second portion of the electronic document that is to include a video feed generated by a second client device of a second participant of the conference call (e.g., another presenter of the conference call, etc.).

In some embodiments, the first video feed integration object and/or the second video feed integration object can be associated with an identifier for a particular user and/or a particular client device connected to the conference platform. For example, a creator and/or editor of the electronic document can provide an indication (e.g., via the conference platform GUI or another GUI, such as an collaborative document platform GUI) that the first region indicated by the first video feed integration object is to include the video feed generated by the first client device during presentation of the first portion of the electronic document and/or that the second region indicated by the second video feed integration object is to include the video feed generated by the second client device during presentation of the second portion of the electronic document. In other or similar embodiments, the first video feed integration object and/or the second video feed integration object may not be associated with an identifier for a particular user and/or a particular client device. Instead, the creator and/or editor of the electronic document can provide an indication that first video feed integration object and/or the second video feed integration object is to provide the video feed associated with a client device that satisfies particular criteria (e.g., an audio recording component of the client device is unmuted, a camera component of the client device is activated, etc.) during presentation of the first portion and/or the second portion of the electronic device. Accordingly, the conference platform can identify the first client device and/or the second client device for obtaining and presenting video feed by determining that the first client device and/or the second client device satisfy the particular criteria during the presentation of the first portion and/or the second portion of the electronic document.

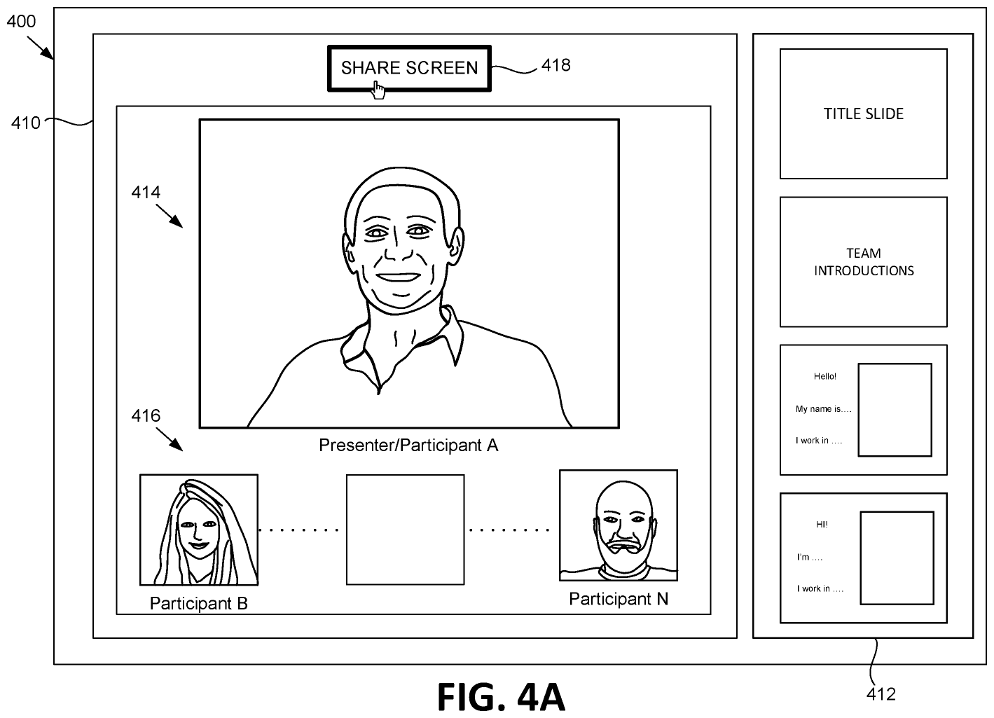

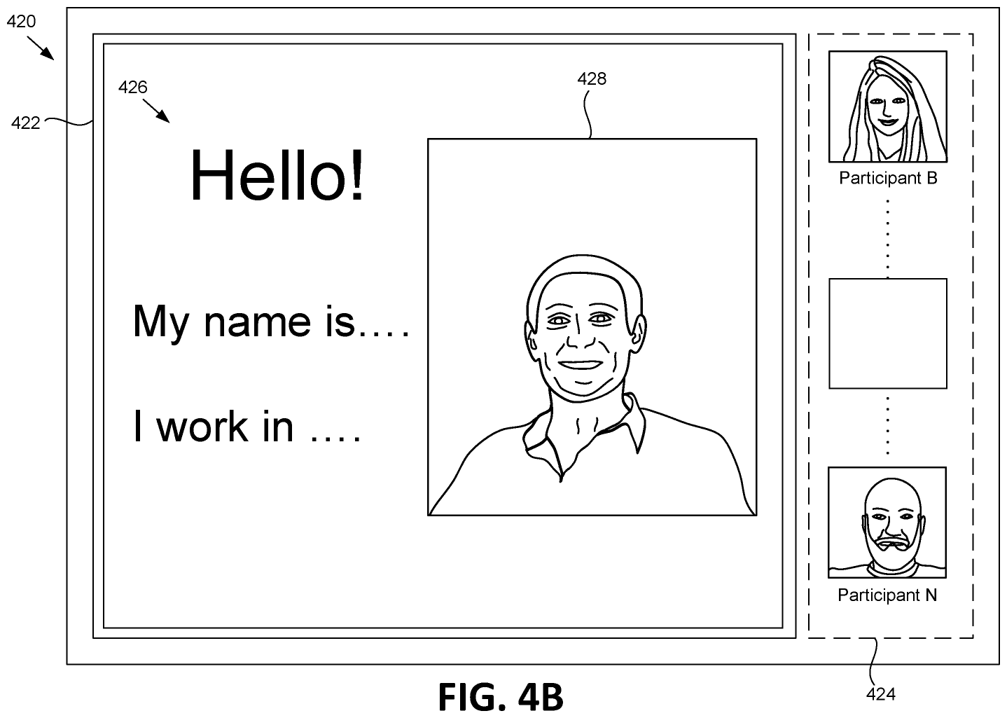

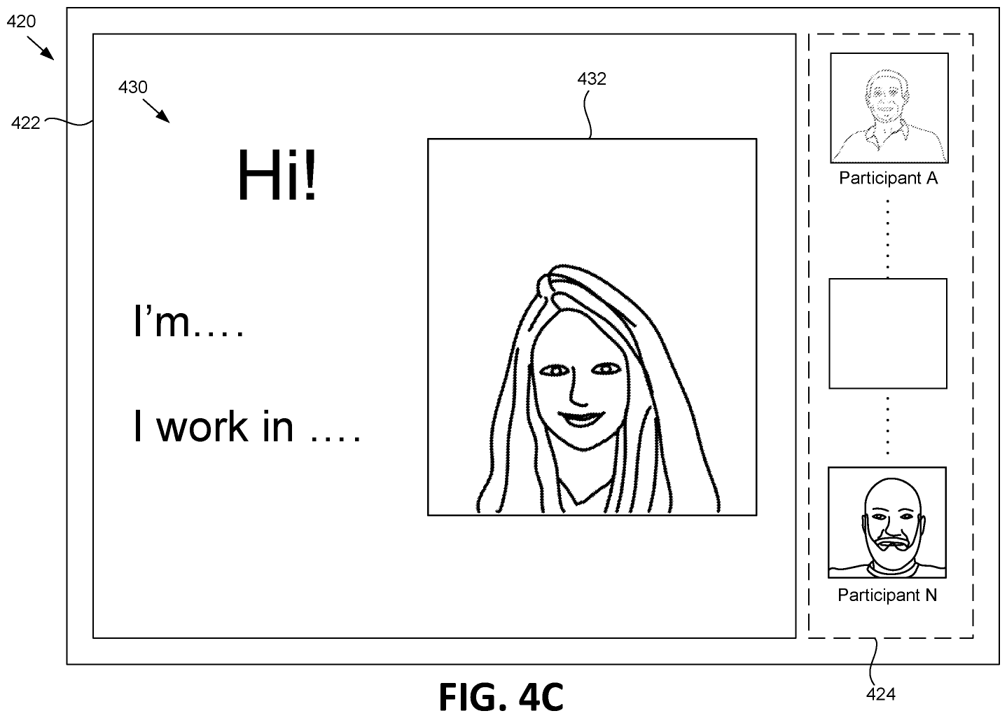

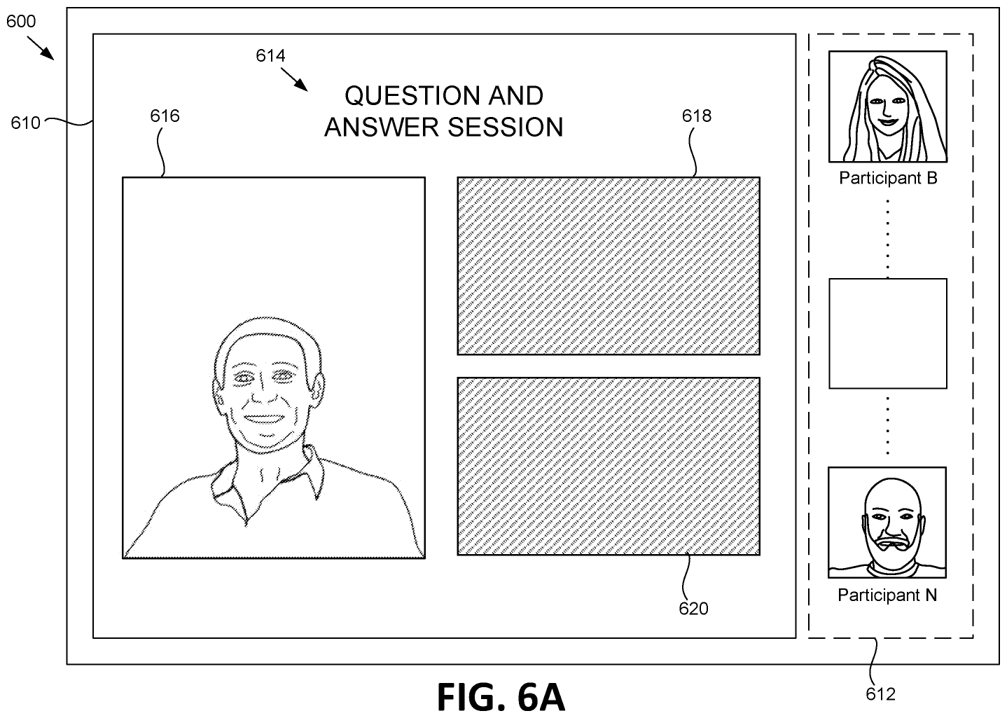

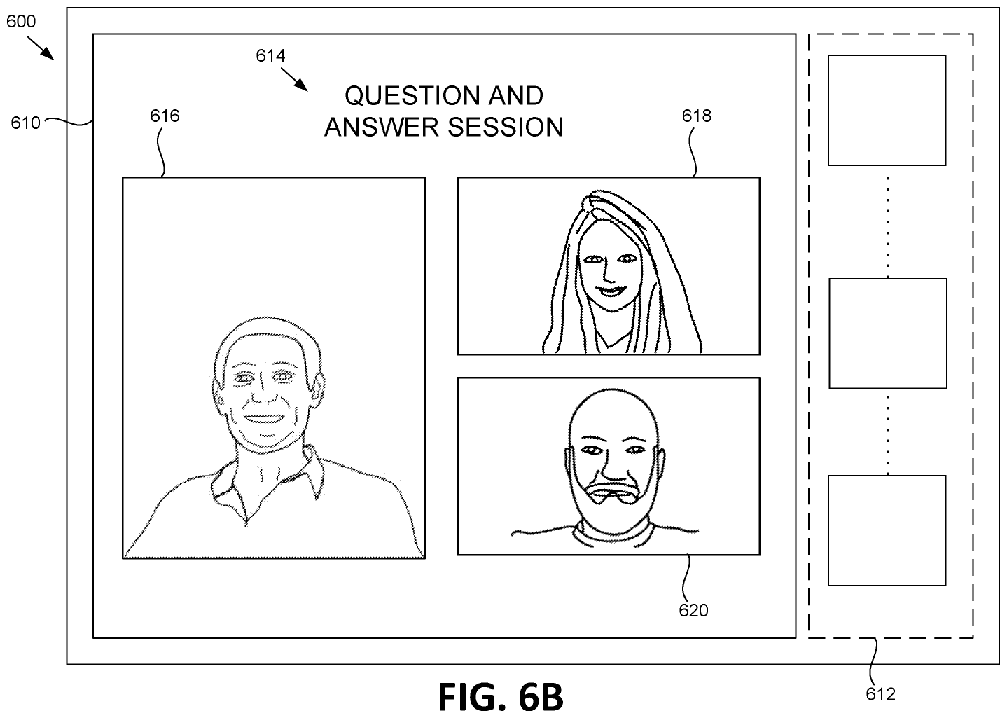

In response to receiving the request to initiate the document sharing operation, the conference platform can identify the electronic document and can provide the first portion and/or the second portion of the electronic document for presentation via the conference platform GUI. When the first portion of the electronic document is presented via the conference platform GUI (e.g., during a first time period), the conference platform can obtain the video feed generated by the first client device (e.g., during the first time period) and include the obtained video feed in the first region indicated by the first video feed integration object. The video feed can depict the first participant of the conference call during presentation of the first portion of the electronic document. Accordingly, the video feed depicting the first participant can be integrated with the first portion of the shared electronic document. Similarly, when the second portion of the electronic document is presented via the conference platform GUI (e.g., during a second time period), the conference platform can obtain the video feed generated by the second client device (e.g., during the second time period) and include the obtained video feed in the second region indicated by the second video feed integration object. The video feed can depict the second participant during presentation of the second portion of the electronic document. Accordingly, the video feed depicting the second participant can be integrated with the second portion of the shared electronic document. Examples of the video feed(s) associated with a first client device and/or a second client device are depicted in FIGS. 4B-4C and FIGS. 6A-6B, which are described in further detail herein.

Aspects of the present disclosure provide techniques to integrate video feeds of one or more presenters of a conference call discussion with a shared document during the conference call discussion. Aspects of the present disclosure enable a creator and/or editor of an electronic document to indicate which regions of an electronic document should include video feeds associated with respective presenters of a conference call discussion. The creator and/or editor can further specify, for the indicated regions, a particular presenter and/or a particular client device (e.g., that satisfies one or more criteria during the presentation) such that the conference platform can obtain the video feeds depicting such presenters and/or generated by such client devices and include the obtained video feeds in the indicated regions of the shared document during the conference call discussion. When the electronic document is shared with participants of the conference call discussion via a conference platform GUI, the conference platform can include the video feeds of the particular presenters and/or generated by the particular client devices in the indicted regions. Accordingly, embodiments of the present disclosure provide mechanisms to present a video feed of a conference call presenter in a specified region of an electronic document shared during a conference call discussion. An electronic document creator and/or editor can more effectively plan for a conference call discussion by indicating particular regions of an electronic document that should include a video feed for a respective conference call presenter. The conference call presenter is able to effectively engage with the participants of the conference call discussion, as the video feed of the presenter is integrated with the content of the electronic document, instead of in a separate portion of the conference platform GUI. Additionally, conference call participants are able to consume the content included in the document as well as the image depicting the presenter. As such, conference call discussions can be conducted effectively and efficiently. As conference call discussions are conducted effectively and efficiently, a conference platform, accordingly, can consume a fewer amount of computing resources (e.g., processing cycles, memory space, etc.) and such resources can be made available to other processes associated with the conference platform or other systems.

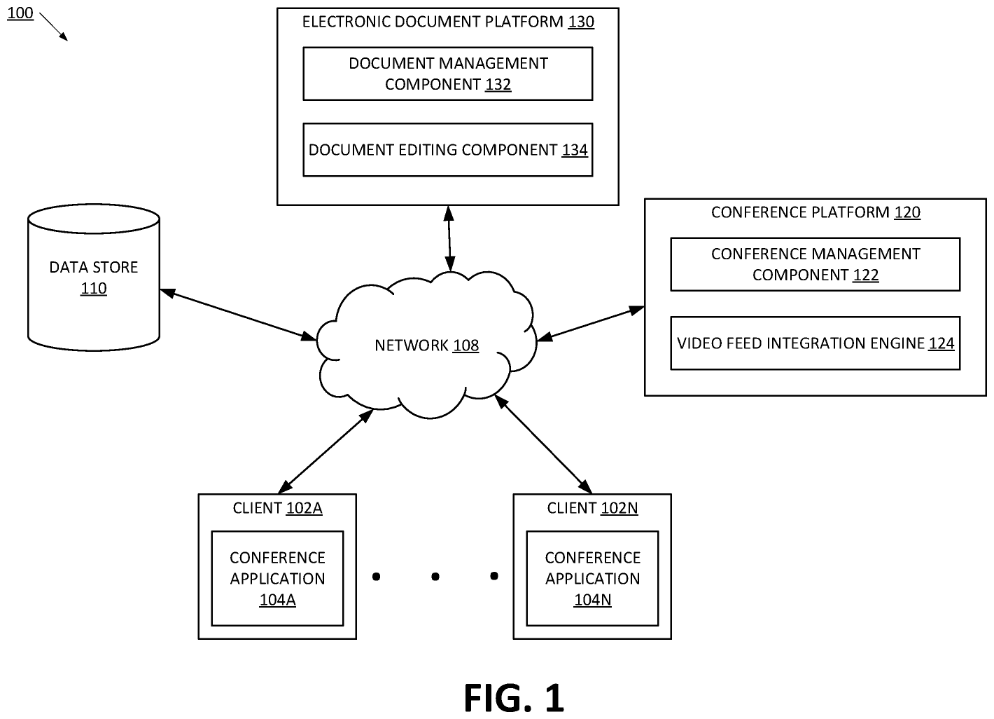

FIG. 1 illustrates an example system architecture 100, in accordance with implementations of the present disclosure. The system architecture 100 (also referred to as “system” herein) includes client devices 102A-N, a data store 110, a conference platform 120, and a collaborative document platform 130 each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or image data, in accordance with embodiments described herein. In other or similar embodiments, a data item can correspond to a document displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by conference platform 120 and/or collaborative document platform 130 or one or more different machines coupled to the conference platform 120 and/or collaborative document platform 130 via network 108.

Conference platform 120 can enable users of client devices 102A-N to connect with each other via a conference call, such as a video conference call or an audio conference call. A conference call refers to an audio-based call and/or a video-based call in which participants of the call can connect with multiple additional participants. Conference platform 120 can allow a user to join and participate in a video conference call and/or an audio conference call with other users of the platform. Although embodiments of the present disclosure refer to multiple participants (e.g., 3 or more) connecting via a conference call, it should be noted that embodiments of the present disclosure can be implemented with any number of participants connecting via the conference call (e.g., 2 or more). Further details regarding conference platform 120 are provided below.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Each client device 102A-N can include a web browser and/or a client application (e.g., a mobile application or a desktop application). In some implementations, the web browser and/or the client application can display a graphical user interface (GUI) provided by conference platform 120 for users to access conference platform 120. For example, a user can join and participate in a video conference call or an audio conference call via a GUI provided by conference platform 120 and presented by the web browser or client application. In other or similar implementations, the web browser and/or the client application can display a GUI provided by collaborative document platform 130 for users to access collaborative document platform 130. For example, a user can access (e.g., create, edit, view, etc.) a collaborative document via the GUI provided by collaborative document platform 130 and presented by the web browser or client application.

Each client device 102A-N can include one or more audiovisual components that can generate audio and/or image data to be streamed to conference platform 120. In some implementations, an audiovisual component can include a device (e.g., a camera) that is configured to capture images and generate image data associated with the captured images. For example, a camera for a client device 102 can capture images of a participant of a conference call in a surrounding environment (e.g., a background) during the conference call. In additional or alternative implementations, an audiovisual component can include a device (e.g., a microphone) to capture an audio signal representing speech of a user and generate audio data (e.g., an audio file) based on the captured audio signal. The audiovisual component can include another device (e.g., a speaker) to output audio data to a user associated with a particular client device 102A-N.

Electronic document platform 130 can enable a user of client devices 102A-N to create, edit (e.g., collaboratively with other users), access, or share with other users an electronic document (e.g., stored at data store 110). In some embodiments, electronic document platform 130 can allow a user to create or edit a file (e.g., an electronic document file, etc.) via a user interface of a content viewer. In some embodiments, each client device 102A-N can include a content viewer. A content viewer can be an application that provides a user interface for users to view, create, or edit content of a file, such as an electronic document file. In one example, the content viewer can be a web browser that can access, retrieve, and/or navigate files served by a web server. In another example, the content viewer can be a standalone application (e.g., a mobile application, etc.) that allows users to view, edit, and/or create digital content items. In some embodiments, the content viewer can be provided by electronic document platform 130. In some embodiments, one or more files that are created or otherwise accessible via the content viewer can be stored at data store 110.

As illustrated in FIG. 1, electronic document platform 130 can include a document management component 132, in some embodiments. Document management component 132 can be configured to manage access to a particular document by a user of electronic document platform 130. For example, a client device 102 can provide a request to electronic document platform 130 for a particular file corresponding to an electronic document. Document management component 132 can identify the file (e.g., stored in data store 110) and can determine whether a user associated with the client device is authorized to access the requested file. Responsive to determining that the user is authorized to access the requested file, document management component 132 can provide access to the file to the client device 102. The client device 102 can provide the user with access to the file via the GUI of the content viewer, as described above.

As indicated above, a user can create and/or edit an electronic document via a GUI of a content viewer of a client device associated with the user. In some embodiments, the electronic document can be or can correspond to a slide presentation document, a word document, a spreadsheet document, and so forth. Electronic document platform 130 can include a document editing component 134, which is configured to enable a user to create and/or edit an electronic document. For example, a client device 102 associated with a user of electronic document platform 130 can transmit a request to electronic document platform 130 to create a slide presentation document based on a slide presentation document template associated with electronic document platform 130. Electronic document platform 130 can generate a file associated with the slide presentation document based on the slide presentation document template and can provide the user with access to the slide presentation document via the content viewer GUI. In another example, a client device 102 associated with a user of electronic document platform 130 can transmit a request to access an electronic document (e.g., a slide presentation document) via the content viewer GUI. Document management component 132 can obtain the file associated with the requested electronic document, as described above, and document editing component 134 can provide the user with access to the electronic document via the content viewer GUI. The user can edit one or more portions of the electronic document via the content viewer GUI and the document editing component 132 can update the file associated with the electronic document to include the edits to the one or more portions.

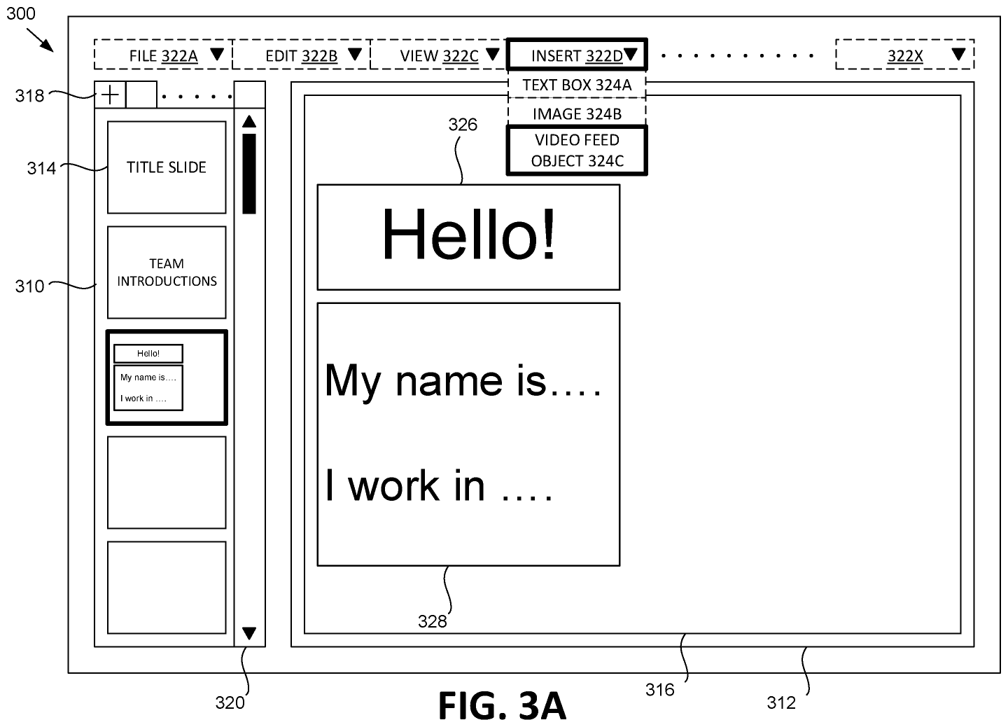

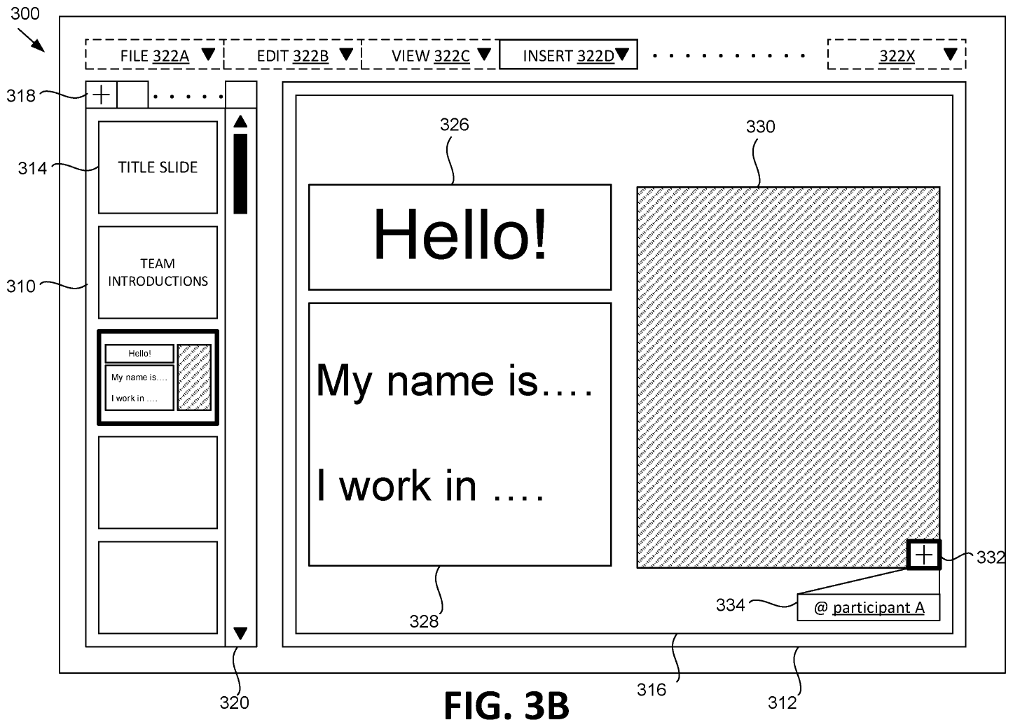

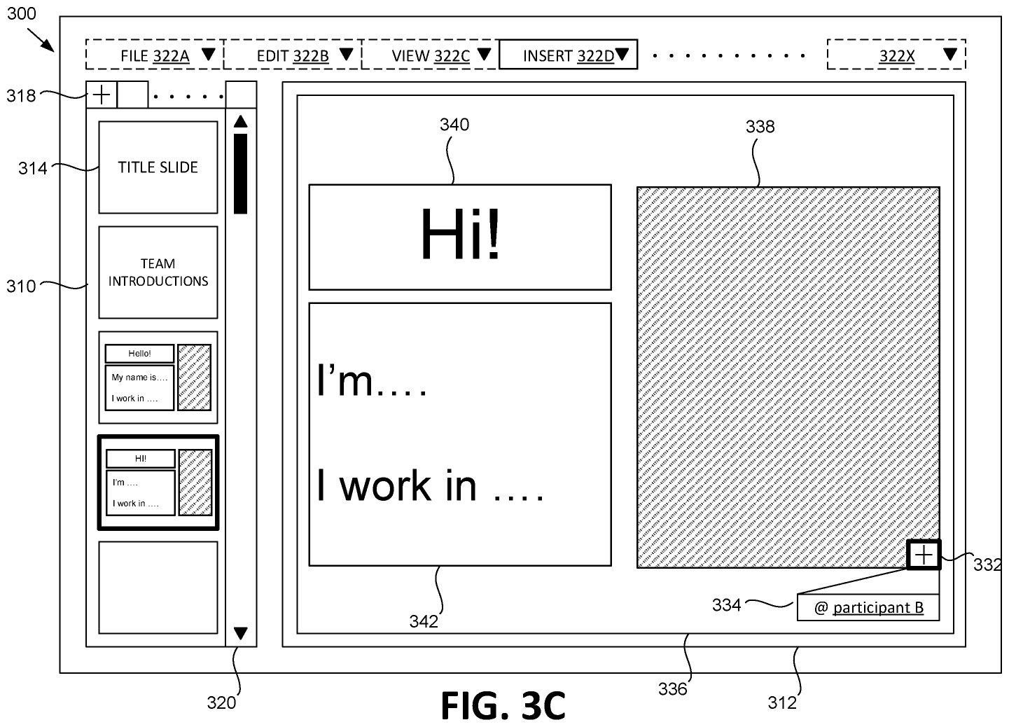

In some embodiments, the user can provide, via the content viewer GUI, an indication of a region of the electronic document that is to include a video feed of a presenter of a conference call discussion (e.g., facilitated by conference platform 120) during a time at which the electronic document is shared with participants of the conference call discussion (e.g., via a conference platform GUI). The user can provide the indication of the region of the electronic document by adding, via the content viewer GUI, a video feed integration object to one or more regions of the electronic document. A region that includes a video feed integration object can indicate a region of the electronic document that is to include a video feed of a presenter, as described above. In some embodiments, the user can add multiple video feed integration objects to distinct portions of the electronic document. The user can also, in some embodiments, provide an indication of a particular user of the conference platform 120 that is to be depicted in the video feed that is included in the region indicated by a respective video feed integration object. In other or similar embodiments, the user can provide an indication of a particular client device 102 connected to the conference platform 120 that is to generate the video feed that is included in the region indicated by the video feed integration object. Further details regarding adding video feed integration objects to portions of an electronic document are provided herein with respect to FIGS. 3A-3C, FIGS. 5A-5B, and FIG. 7.

In some embodiments, conference platform 120 can include a conference management component 122. Conference management component 122 can be configured to manage a conference call between multiple users of conference platform 120. In some embodiments, conference management component 122 can provide a GUI to each client device 102 (referred to as a conference platform GUI herein) to enable users to watch and listen to each other during a conference call. In some embodiments, conference management component 122 can also enable users to share documents (e.g., a slide presentation document, a word processing document, a webpage document, etc.) displayed via a GUI on an associated client device with other users. For example, during a conference call, conference management component 122 can receive a request to share a document displayed via a GUI on a first client device associated with a first participant of the conference call with other participants of the conference call. Conference management platform 122 can modify the conference platform GUI at the client devices 102 associated with the other conference call participants to display at least a portion of the shared document, in some embodiments.

Conference platform 120 can also include a video feed integration engine 124, in some embodiments. Video feed integration engine 124 can be configured to detect whether one or more portions of a document shared with participants of the conference call via the conference platform GUI includes a video feed integration object. In response to determining that the one or more portions of the shared document includes a video feed integration object, video feed integration engine 124 can determine a client device that is to generate the video feed to be integrated into the region of the shared document that includes the video feed integration object. The client device 102 can be associated with a particular participant of the conference call discussion or can satisfy one or more video feed integration criteria. An audiovisual component of the determined client device 102 can generate the video feed and the client device 102 can transmit the generated video feed to the conference platform 120, as described above. Responsive to receiving the video feed, video feed integration engine 124 can provide the video feed in the region indicated by the video feed integration object in the shared document. Further details regarding video feed integration engine 124 and video feed integration objects are provided herein.

In some implementations, conference platform 120 and/or electronic document platform 130 can operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a conference call. In some implementations, the functions of conference platform 120 and/or electronic document platform 130 can be provided by a more than one machine. For example, in some implementations, the functions of conference management component 122 and/or video feed integration engine 124 may be provided by two or more separate server machines. In another example, the functions of document management component 132 and/or document editing component 134 may be provided by two or more separate server machines. Conference platform 120 and/or electronic document platform 130 may also include a website (e.g., a webpage) or application back-end software that may be used to enable a user to connect with other users via the conference call. It should be noted that in some other implementations, the functions of conference platform 120 and/or electronic document platform 130 can be provided by a fewer number of machines. For example, in some implementations conference platform 120 and/or electronic document platform 130 can be integrated into a single machine.

In general, functions described in implementations as being performed by conference platform 120 and/or electronic document platform 130 can also be performed on the client devices 102A-N in other implementations, if appropriate. In addition, the functionality attributed to a particular component can be performed by different or multiple components operating together. Conference platform 120 and/or electronic document platform 130 can also be accessed as a service provided to other systems or devices through appropriate application programming interfaces, and thus is not limited to use in websites.

Although implementations of the disclosure are discussed in terms of conference platform 120 and users of conference platform 120 participating in a video and/or audio conference call, implementations can also be generally applied to any type of telephone call or conference call between users. Implementations of the disclosure are not limited to conference platforms that provide conference call tools to users. In addition, although implementations of the disclosure are discussed in terms of electronic document platform 130 and users of electronic document platform 130 accessing an electronic document, implementations can also be generally applied to any type of documents or files. Implementations of the disclosure are not limited to electronic document platforms that provide document creation, editing, and/or viewing tools to users.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the conference platform 120 and/or electronic document platform 130.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

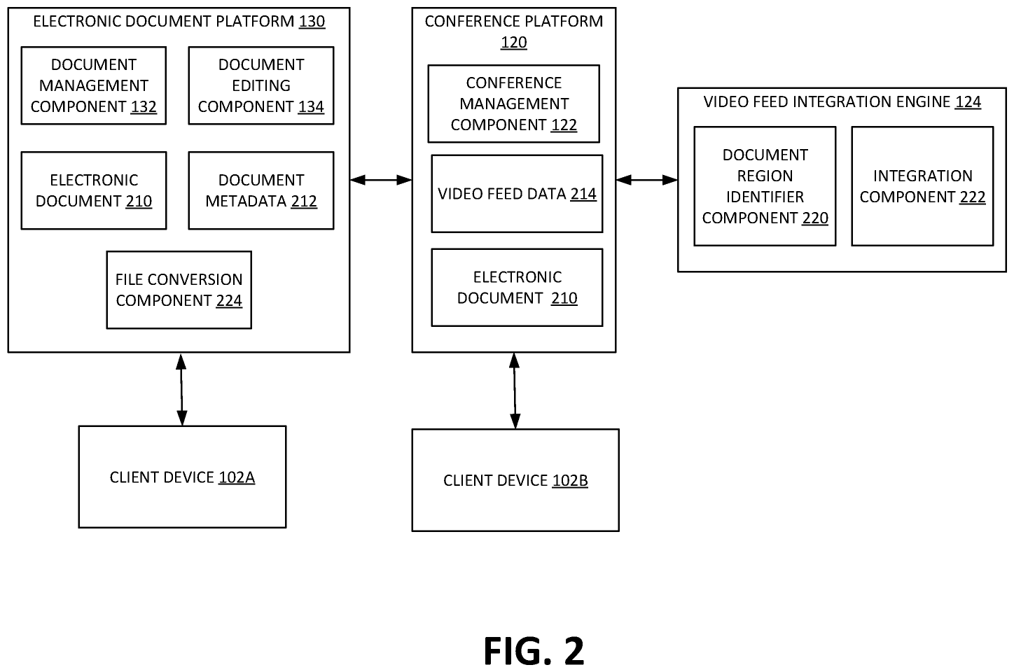

FIG. 2 is a block diagram illustrating an example conference platform 120, and example electronic document platform 130, and an example video feed integration engine 124, in accordance with implementations of the present disclosure. As described with respect to FIG. 1, electronic document platform 130 can provide tools to users of a client device 102 to create, edit, and/or view an electronic document via a GUI of a content viewer of the client device 102. Conference platform 120 can provide tools to users of a client device 102 to join and participate in a video and/or audio conference call.

Electronic document platform 130 can include a document management component 132 and/or a document editing component 134, in some embodiments. As described with respect to FIG. 1, document management component 132 can be configured to manage access to a particular electronic document 210 by a user of electronic document platform 130. Document editing component 134 can be configured to enable a user to create and/or edit an electronic document 210. It should be noted that although FIG. 1 illustrates client device 102A connected to electronic document platform 130, any of client device(s) 102 described with respect to FIG. 1 can be connected to electronic document platform 130 and can be provided with access to electronic document 210, in accordance with embodiments of the present disclosure.

In some embodiments, client device 102A can transmit a request to electronic document platform 130 (e.g., via network 108) to access electronic document 210, as described above. In other or similar embodiments, client device 102A can transmit a request to create and/or edit electronic document 210, as described above. Client device 102A can transmit the request(s) in response to detecting an interaction with one or more GUI elements of the content viewer GUI by a user associated with client device 102A, in some embodiments. Responsive to receiving the request(s), document management component 132 and/or document editing component 134 can provide the user with access to the requested electronic document 210 via the content viewer GUI. FIG. 3A illustrates an example content viewer GUI 300, in accordance with embodiments of the present disclosure. GUI 300 can include a first portion 310 and a second portion 312, in some embodiments. In some embodiments, the first portion 310 can include one or more GUI elements 314 that provide a user with a preview of one or more portions of electronic document 210. For example, electronic document 210 can be a slide presentation document, in some embodiments, first portion 310 can include one or more GUI elements 314 (e.g., thumbnails, etc.) that each include a preview of one or more slides of the slide presentation document. A user can select (e.g., click on, etc.) a particular GUI element 314 to access a respective portion of electronic document 210 via the second portion 312 of GUI 300. As illustrated in FIG. 3A, a particular GUI element 314 included in the first portion 310 of GUI 300 is highlighted, indicating that a user has selected the particular GUI element 314. Accordingly, the user can access the portion of electronic document 210 that is associated with the selected GUI element 314 via the second portion 312 of GUI 300 (e.g., illustrated in FIG. 3A as portion 316).

It should be noted that although embodiments described with respect to FIG. 3A, and other figures of the present disclosure, are directed to a slide presentation document, embodiments of the present disclosure can be directed to any type of electronic document. Therefore, any reference to a slide presentation document herein is not intended to be limiting and should be considered for illustrative purposes only.

In some embodiments, the first portion 310 can include one or more GUI elements 318 that enable a user to modify a number of portions (e.g., slides) that are included in electronic document 210. For example, first portion 310 of GUI 300 can include a GUI element 318 that enables a user to add slides to slide presentation document 210, as illustrated in FIG. 3A. In another example, first portion 310 can include an additional GUI element 318 that enables a user to remove slides from slide presentation document 210. First portion 310 can also include one or more additional GUI elements 320 that enable a user to view previews for each portion of slide presentation document 210. For example, as illustrated in FIG. 3A, first portion 310 can include a scroll bar GUI element 320 that enables a user to scroll through GUI elements 314 to view previews for each portion of slide presentation document 210. It should be noted that other types of GUI elements can be included in portion 310 in addition to or in place of GUI elements 318 and/or 320. In addition, GUI elements 318 and/or 320 can be included in different portions of GUI 300 (e.g., in second portion 312, etc.).

UI 300 can include one or more GUI elements 322 that enable a user to initiate one or more operations associated with electronic document 210. For example, GUI 300 can include a file GUI element 322A that enables a user to initiate one or more file-based operations (e.g., open a file associated with electronic document 210, save updates made to electronic document 210 to the file associated with electronic document 210, etc.). GUI 300 can further include an edit GUI element 322B that enables a user to initiate one or more editing operations associated with electronic document 210 (e.g., initiate a spelling and/or grammar checking operation, etc.), a view GUI element 322C that enables a user to initiate one or more view-based operations associated with electronic document 210, and other types of GUI elements 322X. In some embodiments, GUI 300 can include an inset GUI element 322D that enables a user to insert one or more objects into a region of a portion 316 of electronic document 210. In some embodiments, insert GUI element 322D enables the user to select (e.g., click on, etc.) a particular type of object for insertion (e.g., via a drop down menu, etc.). For example, in response to detecting that a user has selected insert GUI element 322D of GUI 300, document management component 132 and/or document editing component 134 can update GUI 300 to include one or more GUI elements 324 that each enable the user to insert a particular type of object into a region of a portion 316 of electronic document 210. As illustrated in FIG. 3A, GUI 300 can include a text box GUI element 324A that enables a user to insert a text box object into a region of portion 316, an image GUI element 324B that enables a user to insert an image object into a region of portion 316, and/or a video feed object GUI element 324C that enables a user to insert a video feed object into a region of portion 316.

As indicated above, text box GUI element 324A enables a user to insert a text box object into a region of portion 316. For example, in response to a user engaging with (e.g., selecting, clicking on, etc.) text box GUI element 324A, document editing component 134 can update second portion 312 of GUI 300 to include a text box 326. The text box 326 can be overlayed (e.g., displayed on top of) portion 316 of electronic document 210 included in portion 312 of GUI 300. In some embodiments, a user can provide and/or edit text included in text box 326 by engaging with text box 326 and providing text data indicating text to be included in text box 326, e.g., via a peripheral device (e.g., a keyboard device, etc.) of or connected to client device 102B. Client device 102B can receive the text data provided by the user and document editing component 134 can update GUI 300 to include the text included in the provided text data in text box 326. In one example, the user can provide text data associated with the text “Hello!” via the peripheral device. In response to receiving the text data from client device 102B, document editing component 134 can update text box 326 to include the text “Hello!” in text box 326, as illustrated in FIG. 3A. In another example, the user can provide text data associated with the text “My name is . . . ” and/or “I work in . . . ” via the peripheral device. Document editing component 134 can update another text box 328 to include the text “My name is . . . ” and/or “I work in . . . ,” as illustrated in FIG. 3A. In some embodiments, GUI 300 can include one or more additional GUI elements (not shown) that enable the user to modify a format and/or a style associated with text boxes 326 and/or 328. Document editing component 134 can update GUI 300 based on modifications to the format and/or style associated with text boxes 326 and/or 328, as provided by the user (e.g. via a mouse device, a trackpad, etc. connected to client device 102B).

In some embodiments, document editing component 134 can also update a preview provided by a respective GUI element 314 in response to updating portion 316 based on the user provided text and/or style and formatting. For example, in response to updating portion 316 to include the text provided by the user associated with client device 102A, document editing component 134 can update a preview of the portion 316 included in a respective GUI element 314 included in first portion 310 of GUI 300.

As indicated above, video feed object GUI element 324C enables a user to insert a video feed integration object into a region of portion 316. FIG. 3B illustrates adding a video feed integration object 330 into a region of portion 316, in accordance with implementations of the present disclosure. As described above, a video feed integration object 330 can indicate a region of a portion 316 of electronic document 210 that is to include a video feed generated by a client device as the portion 316 is shared via a conference platform GUI during a conference call discussion (e.g., facilitated by conference platform 120). Further details regarding including the video feed in the region indicated by the video feed integration object 330 are provided herein. In one example, in response to a user engaging with (e.g., selecting, clicking on, etc.) video feed object GUI element 324C, document editing component 134 can update second portion 312 of GUI 300 to include the video feed integration object 330. The video feed integration object can be overlayed (e.g., displayed on top of) portion 316 of electronic document 210 included in portion 312 of GUI 300. In some embodiments, a user associated with client device 102A can modify a size and/or shape of the video feed integration object 330 using a peripheral device (e.g., mouse, trackpad, etc.). For example, the user can select one or more corners of video feed integration object 330 and drag the selected corner(s) (e.g., using the peripheral device) to correspond to a target size and/or shape.

In some embodiments, second portion 312 of GUI 300 can include a GUI element 332 that enables a user to indicate a particular user of conference platform 120 that is to be depicted in the video feed that is to be included in the region indicated by video feed integration object 330 and/or a client device 102 that is to generate the video feed that is to be included in the region indicated by video feed integration object 330. For example, in response to engaging with (e.g., selecting, clicking on, etc.) GUI element 332, document editing component 134 can update portion 312 of GUI 300 to include an additional GUI element 334. The additional GUI element 334 can enable the user provide (e.g., type, select, etc.) an identifier associated with a particular user of conference platform 120 and/or a particular client device 102 connected to conference platform 120. In response to providing the identifier associated with the particular user of conference platform 120, document editing component 134 can generate metadata associated with portion 316 of electronic document 210. The generated metadata can include a mapping (e.g., an association, etc.) between the region of portion 316 indicated by video feed integration object 330 and the identifier associated with the particular user and/or the particular client device. The mapping can indicate (e.g., to one or more components of video feed integration engine 124, as described herein) that the video feed associated with the particular participant and/or generated by the particular client device is to be included in the region of portion 316 when portion 316 is shared via the conference platform GUI during the conference call discussion. In one illustrative example, the user can provide an identifier associated with “Participant A” via GUI element 334 to indicate that the video feed associated with “Participant A” is to be included in the region of slide 316 indicated by video feed integration object 330 when slide 316 is shared via the conference platform GUI. As illustrated in FIG. 3C, the user can add another slide to the electronic document 210, in accordance with previously described embodiments, and can add a video feed integration object 338 into slide 336 of electronic document 210, as previously described. The user can also provide an identifier associated with “Participant B” via GUI element 334 to indicate that the video feed associated with “Participant B” is to be included in the region of slide 336 when slide 336 is shared via the conference platform GUI.

As described above, in response to updating portion 312 of GUI 300, document editing component 134 can update a preview associated with the portions 316, 336 of electronic document 210 included in GUI elements 314 of portion 310. For example, in response to adding slide 336 to electronic document 210 and adding text boxes 340 and 342 and video feed integration object 338 into slide 336, document editing component 134 can update a GUI element 314 associated with slide 336 to include a preview of the added text boxes 340 and 342 and/or video feed integration object 338.

As indicated above, some embodiments of the present disclosure reference GUI or GUI elements that are provided via a GUI or GUI of a client device 102. It should be noted that such GUI or GUI elements can refer to any type of GUI or GUI element, including, but not limited to, a button, a drop down menu, a scroll bar, a text box, and so forth.

Referring back to FIG. 2, the user associated with client device 102A can create and/or modify electronic document 210, in accordance with embodiments described above. In some embodiments, document management component 132 and/or document editing component 134 can generate and/or update metadata 212 associated with document 210 based on the user creation and/or modification of electronic document 210. For example, as described above, the user can provide an identifier associated with “Participant A” via element 332 to indicate that the video feed associated with “Participant A” is to be included in the region of slide 316 indicated by video feed integration object 330 when slide 316 is shared via the conference platform GUI. Document management component 132 and/or document editing component 134 can generate a mapping between an identifier associated with “Participant A” and coordinates for the region of slide 316 indicated by video feed integration object 330. The generated mapping can be included in metadata 212. In another example, the user can also provide an identifier associated with “Participant B” via GUI element 332 to indicate that the video feed associated with “Participant B” is to be included in the region of slide 336 when slide 336 is shared via the conference platform GUI. Document management component 132 and/or document editing component 134 can generate a mapping between an identifier associated with “Participant B” and coordinates for the region of slide 336 indicated by video feed integration object 338. The generated mapping can be included in metadata 212. In some embodiments, document management component 132 can store document 210 and/or metadata 212 at data store 110, as indicated above.

As described above, conference platform 120 can provide tools to users of a client device 102 to join and participate in a video and/or audio conference call. Conference management component 122 can manage the conference call between the users of client devices 102. In some embodiments, a respective client device 102B associated with a user of conference platform 120 can connect with other client devices 102 associated with other users of conference platform 120 via network 104. An audiovisual component (e.g., a camera component, a microphone, etc.) of the respective client device 102B can generate visual data and/or audio data associated with the user during the conference call discussion, as described above. The generated visual data and/or audio data is referred to here as video feed data 214. Client device 102B can transmit the video feed data 214 to conference platform 120 (e.g., via network 104). Conference management component 122 can transmit the video feed data 214 received from client device 102B to client devices 102 associated with other users of conference platform 120. Each client device 102B can provide the video feed data to the other users of conference platform 120 via the conference platform GUI.

FIG. 4A illustrates an example conference platform GUI 400, in accordance with implementations of the present disclosure. In some embodiments, conference platform GUI can include a first portion 410 and a second portion 412. The first portion 410 can include a first section 414 and a second section 416 that is configured to display image data (e.g., a video feed) captured by client devices 102 associated with participants of the conference call. For example, as illustrated in FIG. 4A, a video feed associated with a first participant (e.g., Participant A) can be included in a first section 414 of first portion 410. Video feeds associated with additional participants (e.g., Participant B, Participant N, etc.) can be included in a second section 416 of first portion 410. In some embodiments, first section 414 can be designated to include the video feed associated with a participant that is currently speaking. In other or similar embodiments, first section 414 can be designated to include the video feed associated with a participant that is identified or indicated as a presenter of the conference call discussion. In additional or alternative embodiments, first section 410 can include a single portion that displays the video feed captured by client devices of a participant that is currently speaking and/or is identified as a presenter and does not display the video feed captured by client devices 102 of other participants that are not currently speaking and/or are not identified as presenters. In another example, first section 410 can include multiple sections that each display video data associated with a participant of the video conference call, regardless of whether a participant is currently speaking.

In some embodiments, the first portion 410 of GUI 400 can also include one or more GUI elements that enable a presenter of the conference call to share one or more portions of an electronic document with participants of the conference call. For example, the first portion 410 can include a button 418 that enables the presenter to share slides of a slide presentation document (e.g., slide presentation document 210 described above) displayed at second portion 412 with the participants of the conference call. The presenter can initiate an operation to share one or more portions of document 210 with the participants by engaging (e.g., clicking) with button 418. In response to detecting that the presenter has engaged with button 418, the client device (e.g., client device 102B) associated with the presenter can detect that an operation to share at least a portion of document 210 is to be initiated. The client device 102B can transmit a request to initiate the document sharing operation to conference management component 122 of conference platform 120. It should be noted that the presenter can initiate the operation to share document 210 with the participants according to other techniques. For example, a setting for client device 102B can cause the operation to share a portion of document 210 to be initiated in response to detecting that document 210 has been retrieved from local memory of client device 102B and is displayed at second portion 412 of GUI 400.

Referring back to FIG. 2, conference management component 122 can share one or more portions of electronic document 210 with participants of a conference call, in accordance with embodiments of the present disclosure. In some embodiments, electronic document platform 130 can transmit a file associated with the electronic document 210 to conference management component 122. Conference management component 122 can share one or more portions of electronic document 210 in response to receiving the file from electronic document platform 130. In other or similar embodiments, conference management component 122 can retrieve a file associated with electronic document 210 from data store 110 and can share one or more portions of the electronic document 210 based on the retrieved file.

Video feed integration engine 124 can be configured to integrate a video feed associated with a participant (e.g., a presenter) of the conference call discussion with a portion of electronic document 210 while the portion of electronic document 210 is shared via the conference platform GUI. In some embodiments, video feed integration engine 124 can include a document region identifier component 220 (also referred to as document region identifier 220 herein) and/or an integration component 222. FIG. 4B illustrates an example conference platform GUI 420, in accordance with implementations of the present disclosure. In some embodiments, GUI 420 can include at least a first portion 422. The first portion 422 can be configured to display a portion of electronic document 210 that is shared with participants of the conference call. In an illustrative example, the electronic document 210 that is shared via GUI 420 can correspond to the slide presentation document described with respect to FIGS. 3A-3B. As illustrated in FIG. 4B, the first portion 422 of GUI 420 can display portion 316 (e.g., slide 316) of the slide presentation document 210. In some embodiments, GUI 420 can, optionally, include a second portion 424 that is configured to provide video data (e.g., video feeds) captured by client devices 102 associated with participants of the conference call. As illustrated in FIG. 4B, second portion 424 can include the video feed associated with Participant B, Participant N, and so forth.

As described above, the first portion 422 of GUI 420 can display portion 316 of the slide presentation document 210. Document region identifier component 220 can determine whether portion 316 includes one or more video feed integration objects. In some embodiments, document region identifier component 220 can determine whether portion 316 includes a video feed integration object in response to conference management component 122 receiving a request to share portion 316 via GUI 420. In other or similar embodiments, document region identifier component 220 can determine whether portion 316 includes a video feed integration object in response to detecting that conference management component 122 has initiated a sharing operation to share portion 316 via GUI 420.

Document region identifier 220 can determine whether portion 316 includes a video feed integration object by identifying each object associated with portion 316 and determining whether a respective object is associated with a video feed integration object type. For example, document region identifier 220 can identify objects 326, 328, and/or 330 associated with portion 316. Document region identifier 220 can determine (e.g., based on metadata associated with document 210) that objects 326 and 328 are text box objects and therefore are not associated with the video feed integration object type. Document region identifier 220 can determine that object 330 is a video feed integration object and therefore is associated with the video feed integration object type. Accordingly, document region identifier 220 can determine that a video feed is to be integrated with the region of portion 316 that is indicated by the video feed integration object 330.

Document region identifier 220 can provide an indication of the region of portion 316 that includes video feed integration object 330 to integration component 222 of video feed integration engine 124. In some embodiments, integration component 222 can determine whether video feed integration object 330 is associated with a particular participant of the conference call and/or a particular client device 102 connected to conference platform 120. For example, integration component 222 can parse through metadata 212 associated with document 210 to identify a mapping associated with video feed integration object 330. Integration component 222 can determine, based on the identified mapping, that video feed integration object 330 is associated with Participant A. Integration component 222 can determine a client device associated with Participant A (e.g., client device 102B). In some embodiments, the mapping included in metadata 212 can include an identifier for the client device associated with Participant A. Accordingly, integration component 222 can determine that client device 102B is associated with Participant A based on the mapping. In other or similar embodiments, integration component 222 can determine that client device 102B is associated with Participant A based on a user profile associated with Participant A (e.g., maintained by conference platform 120, etc.).

In response to determining that client device 102B is associated with Participant A, integration component 222 can obtain video feed data 214 associated with Participant A, in accordance with previously described embodiments. The video feed data 214 can include a video feed depicting Participant A during the conference call that is generated by an audiovisual component of client device 102B, as described above. Integration component 222 can cause the video feed to be provided to other participants of the conference call in the region of portion 316 indicated by the video feed integration object 330. As illustrated in FIG. 4B, a first section 426 of the first portion 422 of GUI 420 can include the text associated with text box objects 326 and 328, as described with respect to FIG. 3B. A second section 428 of the first portion 422 of GUI 420 can be associated with the video feed integration object 330. Accordingly, integration component 222 can integrate the video feed associated with Participant A in the second section 428 of the first portion 422 of GUI 420.

In some embodiments, conference management component 122 can receive a request to share a different portion of electronic document 210 via conference platform GUI 420. For example, conference management component 122 can receive a request to present portion 336 (e.g., slide 336) of the slide presentation document 210 via GUI 420 (e.g., in response to a transition by the presenter from slide 316 to slide 336). In response to receiving the request, document region identifier component 220 can determine that video feed integration object 338 is included in portion 336, as described above, and can provide an indication of the region of portion 336 that includes video feed integration object 338 to integration component 222. Integration component 222 can determine, based on metadata 212 associated with electronic document 210, that video feed integration object 338 is associated with Participant B of the conference call. Integration component 222 can obtain the video feed associated with Participant B, as described above, and can include the obtained video feed in the region of the first portion 422 of GUI 420 that is indicated by video feed integration object 338. As illustrated in FIG. 4C, conference management component 122 can cause portion 336 of electronic document 210 to be presented via the first portion 422 of GUI 420. A first section 430 of the first portion 422 can include text that was provided via text box objects 340 and 343, described with respect to FIG. 3C. A second section 432 of the first portion 422 can be associated with video feed integration object 338. Accordingly, integration component 222 can integrate the video feed associated with Participant B in the second section 432 of the first portion 422 of GUI 420.

In some embodiments, conference management component 122 can update the second portion 424 of GUI 420 to include the video feeds of participants of the conference call that are not current presenters of portion 336 of electronic document 210. For example, conference management component 122 can update second portion 424 to include the video feed associated with Participant A (e.g., as Participant A is not a presenter for portion 336 of electronic document 210).

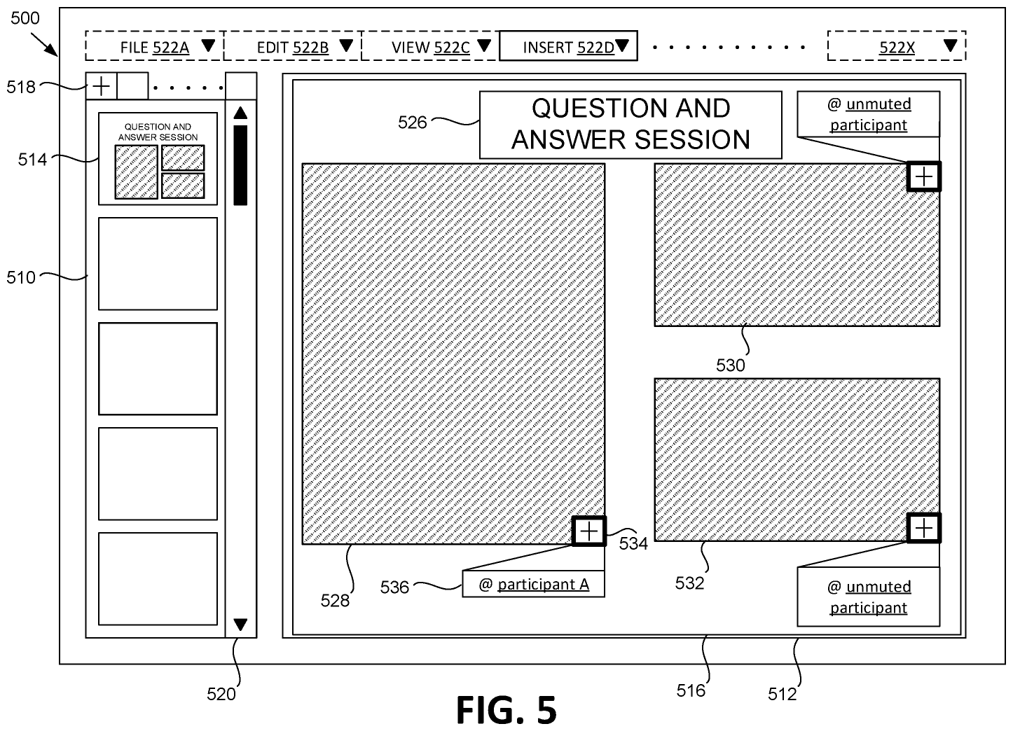

As described above, in some embodiments, a user of electronic document platform 130 may not specify a particular user of conference platform 120 and/or a particular client device connected to conference platform 120 for a respective video feed integration object. Instead, the user of electronic document platform 130 may specify one or more video integration criteria for a respective video feed integration object. Integration component 222 of video feed integration engine 124 can integrate a video feed associated with a particular participant and/or generated by a particular client device 102 in response to determining that the video integration criteria are satisfied. FIG. 5 illustrates another example content viewer GUI 500, in accordance with embodiments of the present disclosure. GUI 500 can include one or more GUI elements that correspond to GUI elements of GUI 300, described with respect to FIGS. 3A-3C. For example, GUI 500 can include a first portion 510 and a second portion 512, which can correspond to portions 310 and 312 of GUI 300. First portion 510 can include GUI elements 314, which correspond to GUI elements 314 of GUI 300. First portion 510 can also include GUI elements 518 and/or 520, which can correspond to GUI elements 318 and/or 320 of GUI 300. Second portion 512 can include a portion 516 of an electronic document (e.g., electronic document 210 or another electronic document), as described above. GUI 500 can also include one or more GUI elements 522, which can correspond to GUI elements 322 of GUI 300. In some embodiments, GUI 500 can further include one or more GUI elements (not shown) that correspond to GUI elements 324 of GUI 300.

In some embodiments, a user of electronic document platform 130 can insert one or more objects into regions of portion 516 of the electronic document, as described above. For example, the user can insert one or more text box objects (e.g., text box object 526), one or more image objects (not shown) and/or one or more video feed integration objects (e.g., objects 528, 530, and/or 532). The user can provide text to be included in the one or more text boxes (e.g., “Question and Answer Session”), as described above. As described with respect to FIGS. 3A-3C, the user can insert the one or more video feed integration objects 528, 530, 532 and can modify a size and or shape of the video feed integration objects 528, 530, 532. In some embodiments, each video feed integration object 528, 530, 532 can include a GUI element 534 that enables the user to indicate a particular user of conference platform 120 that is to be depicted in the video feed to be included in the region indicated by the video feed integration object 528, 530, 532 and/or a client device 102 that is to generate the video feed to be included in the region indicated by video feed integration object 528, 530, 532. For example, as illustrated in FIG. 5, in response to detecting that the user has engaged with GUI element 534 associated with video feed integration object 528, document editing component 134 can update portion 512 of GUI 500 to include an additional GUI element 536 that enables the user to provide an identifier associated with a particular user of conference platform 120 and/or a particular client device 102 connected to conference platform 120. Document editing component 134 can generate metadata indicating a mapping between the video feed integration object 528 and the provided identifier, in accordance with previously described embodiments.

In additional or alternative embodiments, element 524 can enable the user to indicate one or move video feed integration criteria that a client device 102 is to meet in order for the video feed generated by the client device 102 to be included in the region of portion 516 that is indicated by a video feed integration object. For example, as illustrated in FIG. 5, the user can engage with GUI element 534 associated with video feed integration object 530 and/or 532. In response to detecting that the user has engaged with GUI element 534, documents editing component 134 can update portion 512 of GUI 500 to include an additional GUI element 536 that enables the user to provide an indication of criteria that is to be met for a video feed to be included in the region indicated by the video feed integration object 530 and/or 532. In one example, the criteria can provide that a video feed associated with a client device is to be included in the region indicated by video feed integration object 530 and/or 532 if a microphone component associated with the client device is active (e.g., is unmuted, etc.). In another example the criteria can provide that the video feed is to be included if a camera component associated with the client device is active (e.g., is unmuted, etc.). It should be noted that other types of criteria can be provided. Document editing component 134 can generated metadata indicating a mapping between video feed integration object 530 and/or 532 and the provided video feed integration criteria, in accordance with the previously described embodiments.

As illustrated in FIG. 6A, portion 516 can be shared via a conference platform GUI 600 during a conference call, as described above. In some embodiments, GUI 600 can correspond to GUI 420 described with respect to FIGS. 4B-4C. For example, GUI 600 can include a first portion 610 and a second portion 612, which correspond to first portion 422 and second portion 424 of GUI 420. Document region identifier 220 of video feed integration engine 124 can determine whether portion 516 of electronic document 210 includes any video feed integration objects, as described above, and can provide an indication of the regions that include the video feed integration objects to integration component 222. Integration component 222 can determine whether any particular participants and/or client devices are associated with each respective video feed integration object, as described above. For example, integration component 222 can determine that video feed integration object 528 is associated with Participant A based on metadata 212 associated with electronic document 210. Integration component 222 can also determine that video feed integration objects 530 and/or 532 are associated with a video feed integration criteria based on metadata 212. In accordance with the example provided with respect to FIG. 5, the video feed integration criteria can provide that the video feed generated by a particular client device 102 connected to conference platform 120 is to be included in the region of portion 516 indicated by video feed integration objects 530 and/or 532 if a microphone of the client device 102 is unmuted. During a time at which portion 516 is shared via GUI 600, the microphones of client devices 102 associated with Participant B and Participant N can be muted. Accordingly, integration component 222 can determine that no client devices 102 connected to conference platform 120 satisfy the criteria and, accordingly, no video feed(s) are included in the regions of portion 516 indicated by video feed integration objects 530 and/or 532. As illustrated in FIG. 6A, the text provided via text box object 526 (e.g. “Question and Answer Session”) is included in a first region 614 of the first portion 610 of GUI 600. The video feed associated with Participant A is include in a second region 616 of the first portion of 610 of GUI 600 (i.e., a region that is indicated by video feed integration object 528). No video feeds are included in a third region 618 and/or a fourth region 620 of the first portion 610 of GUI 600.

Integration component 222 can update GUI 600 to include the video feeds of one or more participants in the third region 618 and/or the fourth region 620 in response to detecting that the video feed integration criteria associated with the video feed integration objects 530 and/or 532 are satisfied. For example, a microphone associated with client device(s) 102 associated with Participant B and/or Participant N can be activated (e.g., unmuted). Accordingly, integration component 222 can determine that the client device(s) 102 satisfy the video feed integration criteria and can include the video feeds generated by the respective client device(s) in third region 618 and/or the fourth region 620. As illustrated in FIG. 6B, the video feed associated with Participant B can be included in third region 618 after integration component 222 detects that a microphone associated with the client device 102 of Participant B is activated (e.g., unmuted). Additionally or alternatively, the video feed associated with Participant N can be included in fourth region 620 after integration component 222 detects that a microphone associated with client device 102 of Participant N is activated (e.g., unmuted). As illustrated in FIG. 6B, conference management component 122 can update the second portion 612 of GUI 600 to remove the video feeds associated with Participant B and/or Participant N (e.g., in response to integration component 222 including the video feeds in regions 618 and/or 620 of portion 610).

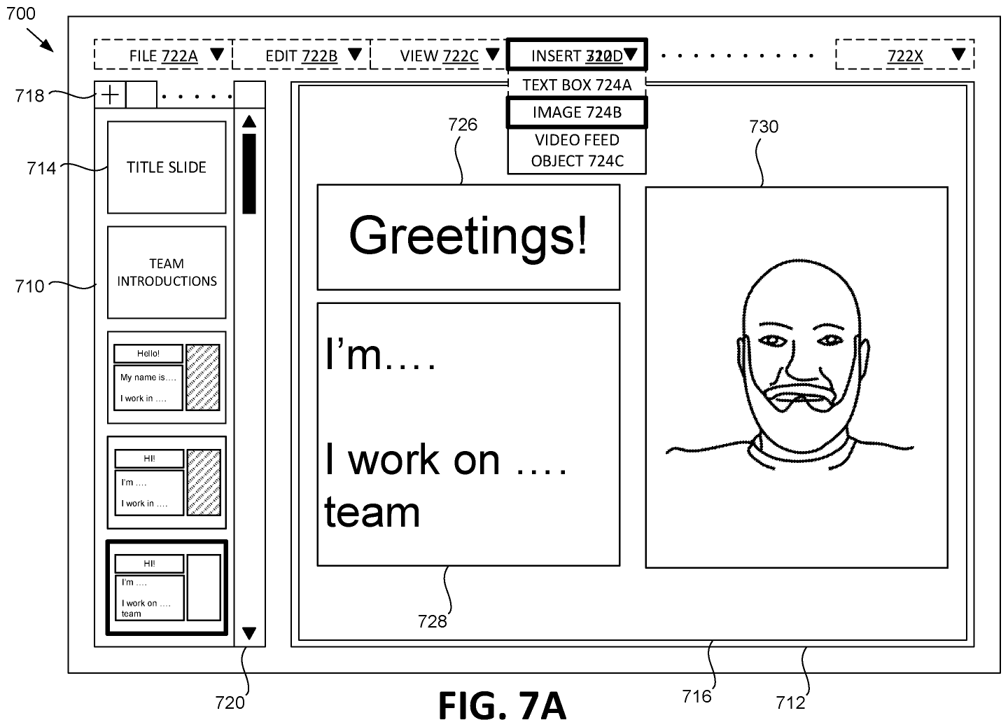

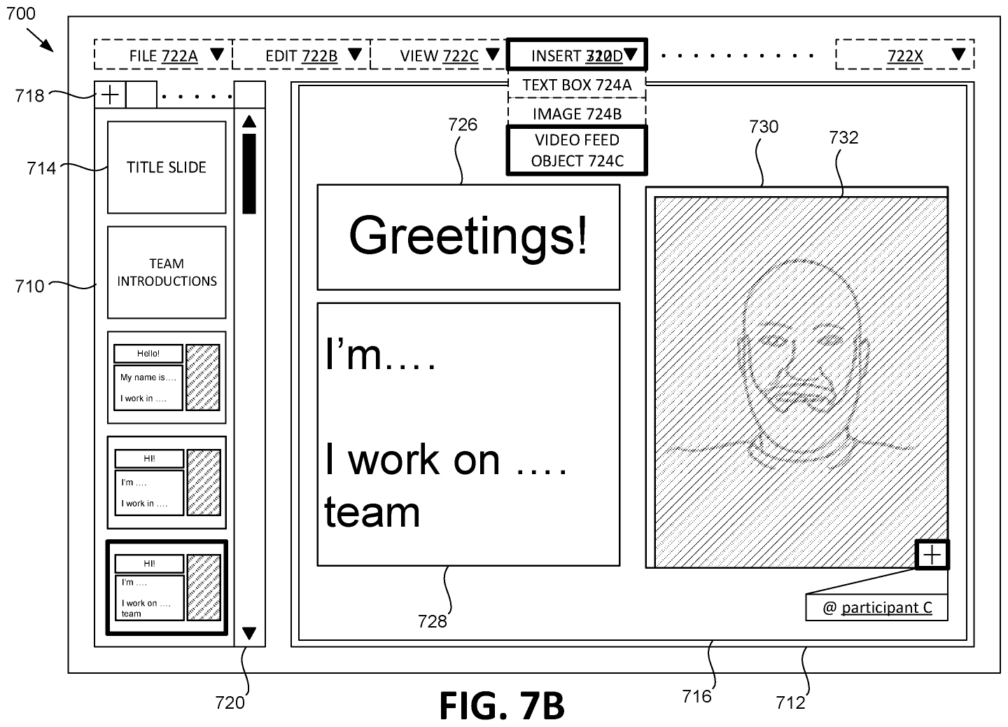

As described previously, in some embodiments, a content viewer GUI (e.g., GUI 300, GUI 500, etc.) can enable a user of electronic document platform 130 to insert an image object into a portion of an electronic document 210. FIG. 7A illustrates another example content viewer GUI 700, in accordance with implementations of the present disclosure. One or more portions and/or GUI elements of GUI 700 can correspond to respective portions and/or elements of GUIs 300 and/or 500, as described above. As illustrated in FIG. 7A, a user of electronic document platform 130 can insert one or more text box objects 726, 728 into a portion 716 (e.g., a slide) of electronic document 210, as described above. The user can provide text to be included in the inserted one or more text box objects 726, 728 (e.g., “Greetings!” and “I'm . . . I work on . . . team.”), as described above. In some embodiments, the user can insert an image object into one or more regions 730 of portion 716. For example, the user can engage with insert GUI element 322D, as described above. In response to detecting that the user has engaged with insert GUI element 322D, document management component 132 and/or document editing component 134 can update GUI 700 to include one or more additional GUI elements 324. The additional GUI elements 324 can include an image object GUI element 324B, as described above. In response to detecting that the user has engaged with the image object GUI element 324B, document management component 132 and/or document editing component 134 can update GUI 700 to include another GUI element (not shown) that enable the user to insert a particular image into the region 730 of portion 716. In some embodiments, the GUI element enables the user to select an image that is stored at a local memory of the client device 102 associated with the user. In other or similar embodiments, the GUI element enables the user to search for an image (e.g., via a web browser, etc.) that is to be downloaded or copied to the client device 102 and included in the region 730 of portion 716. The user can provide an indication of the image that is to be included in region 730 and document management component 132 and/or document editing component 134 can update GUI 700 to include the indicated image in region 730. As illustrated in FIG. 7A, document management component 132 and/or document editing component 134 can update GUI 700 to include an image of a person in region 730 of portion 716 of electronic document 210.

In some embodiments, the user can add additional objects to be overlaid on top of objects included in portion 716 of electronic document 210. For example, after inserting the image into region 730 of portion 716, the user can insert a video feed integration object 732 into portion 716, as described herein. In some embodiments, the user can insert the video feed integration object 732 over top of the image inserted into region 730. As illustrated in FIG. 7B, the user can insert video feed integration object 732 over top of the image included in region 730. The user can also indicate a particular user of conference platform and/or a particular client device 102 connected to conference platform 120 that is to provide video feed to be integrated in region 730, as described above. When portion 716 is shared with participants of a conference call discussion via conference platform 120, video feed integration engine 124 can include the video feed associated with the particular participant and/or generated by the particular client device 102 in the region indicated by video feed integration object 732, in accordance with previously described embodiments. The image included in region 730 may not be displayed via the conference platform GUI, in such embodiments. As described above, in some embodiments, the user of electronic document platform 130 can provide an indication of one or more video feed integration criteria associated with video feed integration object 732. If a client device 102 satisfies the one or more video feed integration criteria, the video feed generated by the client device 102 can be included in the region of portion 716 indicated by video feed integration object 732, as described above. However, if no client device(s) 102 connected to video conference platform 120 satisfy the one or more video feed integration criteria, the image included in region 730 can be presented in the corresponding region of portion 716 that is shared via the conference platform GUI.

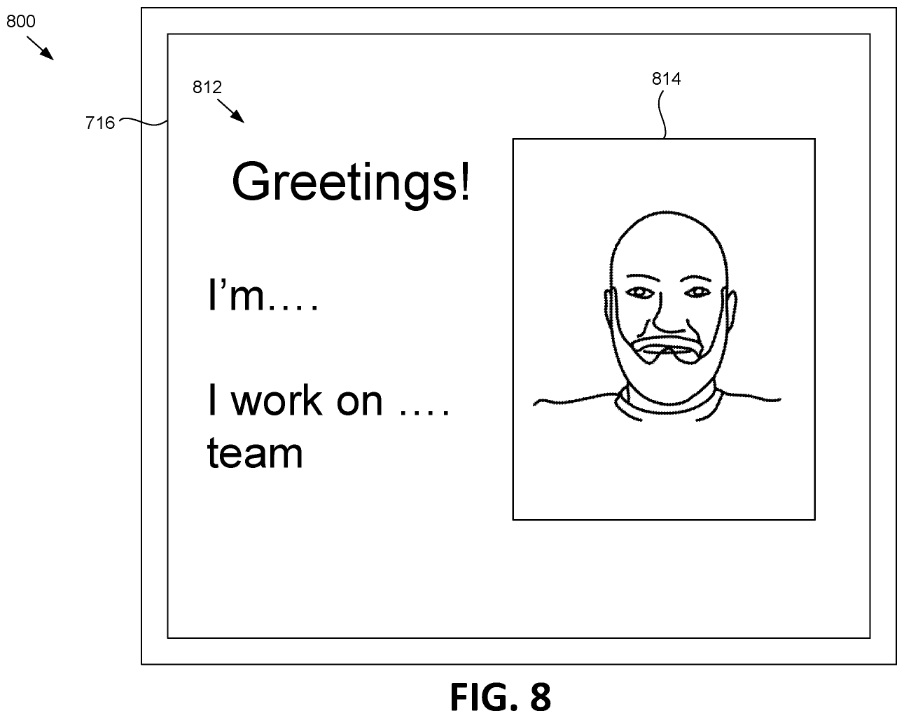

Referring back to FIG. 2, in some embodiments, a user of electronic document platform 130 may wish to convert a file associated with electronic document 210 from a first file format to a second file format. For example, electronic document 210 can be created as a slide presentation document, as described above. The user of platform 130 may wish to convert the file associated with the slide presentation document to another type of document (e.g., a word document, a portable document format (PDF) document, etc.). The client device associated with the user (e.g., client device 102A) can transmit a request to electronic document platform 130 to convert a file associated with electronic document 210 to from the first file type to the second file type. File conversion component 224 of electronic document platform 130 can convert the file associated with the electronic document 210 in response to the request. As described with respect to FIGS. 7A and 7B, in some embodiments, one or more portions of the electronic document can include an image and a video feed integration object over top of the image. When file conversion component 224 converts the electronic document from the first file type to the second file type, the file conversion component 224 can remove (or otherwise omit) the video feed integration object from over top of the included image. FIG. 8 illustrates an example 800 of a portion of electronic document 210 after conversion from the first file type to the second file type. The portion of electronic document 210 can correspond to portion 716 described with respect to FIGS. 7A and 7B. As illustrated in FIG. 8, portion 716 of electronic document 210 can include a first region 812 and a second region 614, The first region 612 of portion 716 can include text provided via one or more text box objects inserted into portion 716 (e.g., “Greetings!,” and “I'm . . . I work on . . . team”). The second region 614 of portion 716 can include the image that was inserted into region 730 of portion 716 via the content viewer GUI 700, described with respect to FIGS. 7A and 7B. As illustrated in FIG. 8, video feed integration object 732 is not included in the example 800 of portion 716.

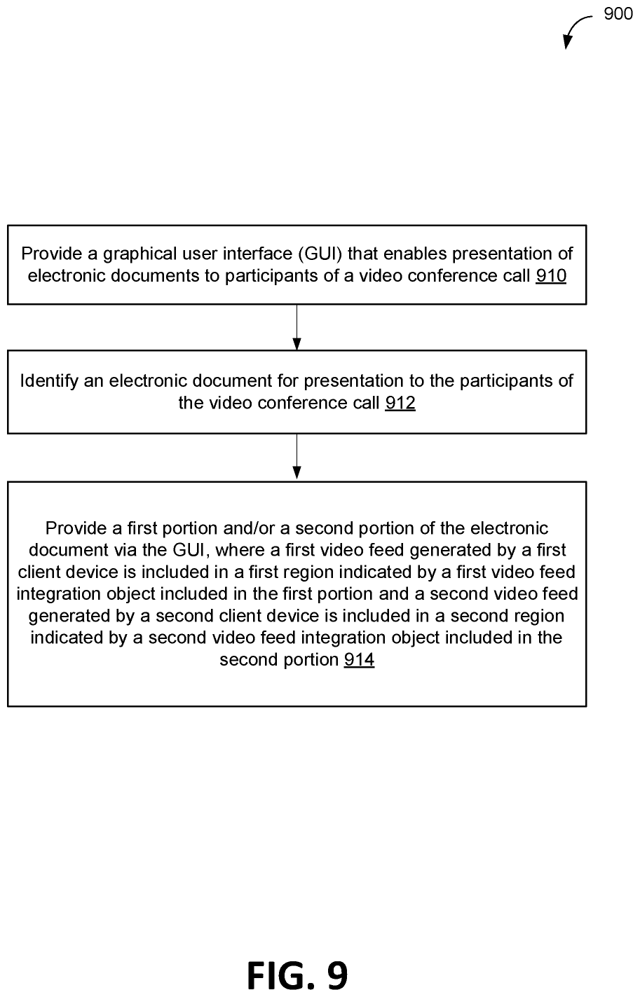

FIG. 9 depicts a flow diagram of an example method 900 for integrating a video feed with a shared document during a conference call discussion, in accordance with implementations of the present disclosure. Method 900 can be performed by processing logic that can include hardware (circuitry, dedicated logic, etc.), software (e.g., instructions run on a processing device), or a combination thereof. In one implementation, some or all the operations of method 900 can be performed by one or more components of system 100 of FIG. 1.

At block 910, processing logic can provide a graphical user interface (GUI) that enables presentation of electronic documents to participants of a video conference call. In some embodiments, the GUI can be a conference platform GUI provided by conference platform 120. At block 912, processing logic can identify an electronic document for presentation to the participants of the video conference call. The electronic document can include a slide presentation document, a word processing document, a spreadsheet document, and/or a webpage document. A first portion of the electronic document can include a first video feed integration object and a second portion of the electronic document can include a second video feed integration object. The first video feed integration object can indicate, for the first portion of the electronic document, a first region to include a first video feed generated by a first client device of a first participant of the video conference call. The second video feed integration object can indicate, for the second portion of the electronic document, a second region to include a second video feed generated by a second client device of a second participant of the conference call.

At block 914, processing logic can provide, for presentation to one or more participants of the video conference call, at least one of the first portion or the second portion of the electronic document via the GUI. The first video feed generated by the first client device is to be included in the first region indicated by the first video feed integration object. The second video feed generated by the second client device is to be included in the second region indicated by the second video feed integration object.

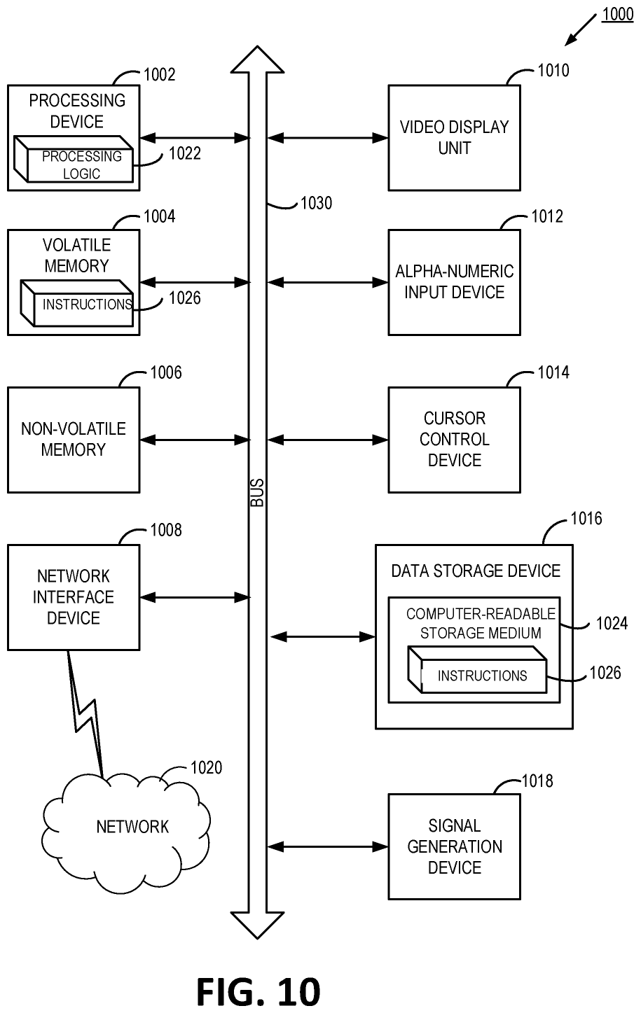

FIG. 10 is a block diagram illustrating an exemplary computer system 1000, in accordance with implementations of the present disclosure. The computer system 1000 can correspond to conference platform 120, collaborative document platform 130, and/or client devices 102A-N, described with respect to FIG. 1. Computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 (e.g., for predicting channel lineup viewership) for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 (e.g., for integrating a video feed with a shared document during a conference call discussion) embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for overlaying an image depicting a conference call participant with a shared document. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
providing a graphical user interface (GUI) that enables presentation of electronic documents to participants of a video conference call;
identifying an electronic document for presentation to the participants of the video conference call, wherein a first portion of the electronic document comprises a first video feed integration object and a second portion of the electronic document comprises a second video feed integration object, the first video feed integration object indicating, for the first portion of the electronic document, a first region to include a first video feed associated with a first client device of a first participant of the video conference call and the second video feed integration object indicating, for the second portion of the electronic document, a second region to include a second video feed associated with a second client device of a second participant of the video conference call; and
providing, for presentation to one or more of the participants of the video conference call, at least one of the first portion or the second portion of the electronic document via the GUI, wherein the first video feed is to be included in the first region indicated by the first video feed integration object, and the second video feed is to be included in the second region indicated by the second video feed integration object.

2. The method of claim 1, wherein providing at least one of the first portion or the second portion of the electronic document via the GUI comprises:
providing, during a first time period, the first portion of the electronic document via the GUI, wherein the first video feed is generated by the first client device during the first time period and is included in the first region of the first portion of the electronic document; and
providing, during a second time period, the second portion of the electronic document via the GUI, wherein the second video feed is generated by the second client device during the second time period and is included in the second region of the second portion of the document.

3. The method of claim 1, wherein providing at least one of the first portion or the second portion of the electronic document via the GUI comprises:
providing the first portion of the electronic document and the second portion of the electronic document via the GUI during a first time period, wherein the first video feed is generated by the first client device during the first time period and is included in the first region of the first portion of the electronic document and the second video feed is generated by the second client device during the first time period and is included in the second region of the second portion of the electronic document.

4. The method of claim 1, further comprising:
identifying metadata associated with the electronic document, wherein the metadata comprises a first mapping between the first video feed integration object and an identifier for at least one of the first client device or the first participant and a second mapping between the second video feed integration object and an identifier for at least one of the second client device or the second participant; and
determining that the first region is to include the first video feed and the second region is to include the second video feed based on the first mapping and the second mapping of the identified metadata.

5. The method of claim 1, further comprising:
determining whether the first client device and the second client device satisfy one or more video feed integration criteria associated with the electronic document; and
determining that the first region is to include the first video feed and the second region is to include the second video feed responsive to determining that the first client device and the second client device satisfy the one or more video feed integration criteria associated with the electronic document.

6. The method of claim 5, wherein determining whether the first client device and the second client device satisfy one or more video feed integration criteria associated with the electronic document comprises:
determining whether at least one of a respective microphone component or a respective camera component of the first client device and the second client device are activated.

7. The method of claim 1, wherein the electronic document comprises at least one of a slide presentation document, a word processing document, a spreadsheet document, or a webpage document.

8. A system comprising:
a memory device; and
a processing device coupled to the memory device, the processing device to perform operations comprising:
providing a graphical user interface (GUI) that enables presentation of electronic documents to participants of a video conference call;
identifying an electronic document for presentation to the participants of the video conference call, wherein a first portion of the electronic document comprises a first video feed integration object and a second portion of the electronic document comprises a second video feed integration object, the first video feed integration object indicating, for the first portion of the electronic document, a first region to include a first video feed associated with a first client device of a first participant of the video conference call and the second video feed integration object indicating, for the second portion of the electronic document, a second region to include a second video feed associated with a second client device of a second participant of the video conference call; and
providing, for presentation to one or more of the participants of the video conference call, at least one of the first portion or the second portion of the electronic document via the GUI, wherein the first video feed is to be included in the first region indicated by the first video feed integration object, and the second video feed generated by the second client device is to be included in the second region indicated by the second video feed integration object.

9. The system of claim 8, wherein providing at least one of the first portion or the second portion of the electronic document via the GUI comprises:
providing, during a first time period, the first portion of the electronic document via the GUI, wherein the first video feed is generated by the first client device during the first time period and is included in the first region of the first portion of the electronic document; and
providing, during a second time period, the second portion of the electronic document via the GUI, wherein the second video feed generated by the second client device during the second time period and is included in the second region of the second portion of the document.

10. The system of claim 8, wherein providing at least one of the first portion or the second portion of the electronic document via the GUI comprises:
providing the first portion of the electronic document and the second portion of the electronic document via the GUI during a first time period, wherein the first video feed generated by the first client device during the first time period and is included in the first region of the first portion of the electronic document and the second video feed is generated by the second client device during the first time period and is included in the second region of the second portion of the electronic document.

11. The system of claim 8, wherein the operations further comprise:
identifying metadata associated with the electronic document, wherein the metadata comprises a first mapping between the first video feed integration object and an identifier for at least one of the first client device or the first participant and a second mapping between the second video feed integration object and an identifier for at least one of the second client device or the second participant; and
determining that the first region is to include the first video feed and the second region is to include the second video feed based on the first mapping and the second mapping of the identified metadata.

12. The system of claim 8, wherein the operations further comprise:
determining whether the first client device and the second client device satisfy one or more video feed integration criteria associated with the electronic document; and
determining that the first region is to include the first video feed and the second region is to include the second video feed responsive to determining that the first client device and the second client device satisfy the one or more video feed integration criteria associated with the electronic document.

13. The system of claim 12, wherein determining whether the first client device and the second client device satisfy one or more video feed integration criteria associated with the electronic document comprises:
determining whether at least one of a respective microphone component or a respective camera component of the first client device and the second client device are activated.

14. The system of claim 8, wherein the electronic document comprises at least one of a slide presentation document, a word processing document, a spreadsheet document, or a webpage document.

15. A non-transitory computer readable storage medium comprising instructions for a server that, when executed by a processing device, cause the processing device to perform operations comprising:
providing a graphical user interface (GUI) that enables presentation of electronic documents to participants of a video conference call;
identifying an electronic document for presentation to the participants of the video conference call, wherein a first portion of the electronic document comprises a first video feed integration object and a second portion of the electronic document comprises a second video feed integration object, the first video feed integration object indicating, for the first portion of the electronic document, a first region to include a first video feed associated with a first client device of a first participant of the video conference call and the second video feed integration object indicating, for the second portion of the electronic document, a second region to include a second video feed associated with a second client device of a second participant of the video conference call; and
providing, for presentation to one or more of the participants of the video conference call, at least one of the first portion or the second portion of the electronic document via the GUI, wherein the first video feed is to be included in the first region indicated by the first video feed integration object, and the second video feed is to be included in the second region indicated by the second video feed integration object.

16. The non-transitory computer readable storage medium of claim 15, wherein providing at least one of the first portion or the second portion of the electronic document via the GUI comprises:
providing, during a first time period, the first portion of the electronic document via the GUI, wherein the first video feed is generated by the first client device during the first time period and is included in the first region of the first portion of the electronic document; and
providing, during a second time period, the second portion of the electronic document via the GUI, wherein the second video feed is generated by the second client device during the second time period and is included in the second region of the second portion of the document.

17. The non-transitory computer readable storage medium of claim 16, wherein providing at least one of the first portion or the second portion of the electronic document via the GUI comprises:
providing the first portion of the electronic document and the second portion of the electronic document via the GUI during a first time period, wherein the first video feed is generated by the first client device during the first time period and is included in the first region of the first portion of the electronic document and the second video feed is generated by the second client device during the first time period and is included in the second region of the second portion of the electronic document.

18. The non-transitory computer readable storage medium of claim 15, wherein the operations further comprise:
identifying metadata associated with the electronic document, wherein the metadata comprises a first mapping between the first video feed integration object and an identifier for at least one of the first client device or the first participant and a second mapping between the second video feed integration object and an identifier for at least one of the second client device or the second participant; and
determining that the first region is to include the first video feed and the second region is to include the second video feed based on the first mapping and the second mapping of the identified metadata.

19. The non-transitory computer readable storage medium of claim 15, wherein the operations further comprise:
determining whether the first client device and the second client device satisfy one or more video feed integration criteria associated with the electronic document; and
determining that the first region is to include the first video feed and the second region is to include the second video feed responsive to determining that the first client device and the second client device satisfy the one or more video feed integration criteria associated with the electronic document.

20. The non-transitory computer readable storage medium of claim 19, wherein determining whether the first client device and the second client device satisfy one or more video feed integration criteria associated with the electronic document comprises:
determining whether at least one of a respective microphone component or a respective camera component of the first client device and the second client device are activated.
